(19) United States
(12) Patent Application Publication
(10) Pub. No.: US 2013/0276349 A1
(43) Pub. Date: Oct. 24, 2013

(54) Fish Attractor

(71) Applicants: Zachary O. Tigner, Albany, OR (US); Seth A. Tigner, Albany, OR (US)

(72) Inventors: Zachary O. Tigner, Albany, OR (US); Seth A. Tigner, Albany, OR (US)

(21) Appl. No.: 13/450,436

(22) Filed: Apr. 18, 2012

(51) Int. Cl. A01K 85/00

(52) U.S. Cl. 43/42.19

(57) ABSTRACT

A fish attractor with a substantially planar body having an aperture at the apex and one centrally located in the base, and a substantially larger opening positioned centrally in the plane. Disposed in the larger opening is a spinner which spins as the fish attractor is drawn through the water and produces vibration and sound as it spins.

### FIELD OF INVENTION

The present device relates to fish attractors and lures, and more particularly, to fish attractors and lures adapted to rotate, flash or otherwise attract fish when drawn through water.

### BACKGROUND OF THE INVENTION

Over the years there have been a great many forms of fishing lures and attractors. Often the primary purpose of such an attractor is to provide visual stimulus to attract a fish or cause a fish to approach a line or strike.

Sport fishing often places unique conditions on fishing lures and combines the need for simplicity and durability as well as functionality over a wide range of environments. Some lures are used in clear shallow water and some are used deep where there is limited light or limited visibility, and everywhere in between. Similarly, often fish are found near rocks or underwater vegetation, making the environment for fishing often one filled with hazards. Often these conditions are met with a fisherman having a tackle box with a wide variety of lures and gear to meet specific conditions. Similarly, the very nature of fishing which often involved placing the lure in use at the end of a long line which is as light at possible stretched out over great distances often leads to lost lures. Over the years this has lead to competing forces as lures have been designed to meet both specific conditions, maximize attraction of fish and maintain nominal costs as they need to be largely disposable.

One of the common solutions to augmenting the attractive qualities of any lure is the use of a flasher, or largely flat and simple piece of metal or plastic designed to catch the light and attract fish. These economical pieces are generally flat, or with a bend to create movement to attract a fish.

U.S. Pat. No. D363,113 to Hazelquist is one such fish attractor which comprises a large flat piece to be place inline between a hook and line to augment the attractiveness of a lure or bait.

In addition to visual stimulation, fish are also often attracted to auditory signals or vibrations. This is particularly valuable in conditions where light or visibility is limited or where direct line of sight conditions may not be available.

U.S. Pat. No. 4,201,008 to Sparkman for a fishing lure and spinner is designed to create both visual and auditory signals to attract fish by having a rotating spinner to generate bubbles, noise and general vibration to attract fish. However the Sparkman patent is designed to operate on the surface of the water, and with the open spinners needs to be used in an environment that is free from possible entanglements making it unsuitable for a wide range of environments.

Attempts to combine the high visual impact and low cost of flat Hazelquist type flashers with sound and vibration generators have been made, but are largely unsuccessful. One such device is U.S. Pat. No. 6,643,975 to Edwards which attempts to insert a flexible membrane or film into a central portion of the flat body to create vibration. However, the very characteristics of the thin membrane which allow it to generate sound also make it prone to puncture and destruction, this limiting its effectiveness. As well, the vibration and sound created by the membrane of Edwards is limited and at low speeds through the water the Edwards membrane has essentially no auditory or vibrational output.

The prior art is replete with designs for lures and attractors. None, however, discloses the noise-making ability of the present fish attractor with both the economical simplicity and durability and applicability over a wide range of environments.

### SUMMARY

In the preferred embodiment, the present device is comprised of a substantially planar triangular body with an attachment point at one apex for attaching a fishing line that then might go to a fisherman or a pole and a second attachment point at a distal end for attaching a hook or hook assembly or additional fishing lure. Centrally located in the body of the fish attractor is an opening in which is set a spinner which when the fish attractor is drawn through the water is caused to vibrate or rotate.

The device may be made of plastic, metal or a similar rigid or semi-rigid material. It is also useful to incorporate reflective materials such as holographic, Mylar type or metal foils into the material comprising the body of the fish attractor and the spinner or in laminates or films applied to the body of the fish attractor and spinner.

### BRIEF DESCRIPTION OF THE DRAWINGS

The above description and other objects, advantages, and features of the present embodiment will be more fully understood and appreciated by reference to the specification and accompanying drawings, wherein:

FIG. 1 is a perspective view of a preferred embodiment with a two bladed spinner.

FIG. 2 is a top plan view of a preferred embodiment with a four bladed spinner.

FIG. 3 is a top plan view of a preferred embodiment with a two bladed spinner.

FIG. 4 is a rear plan view of a preferred embodiment with a four bladed spinner.

FIG. 5 is a rear plan view of a preferred embodiment with a two bladed spinner.

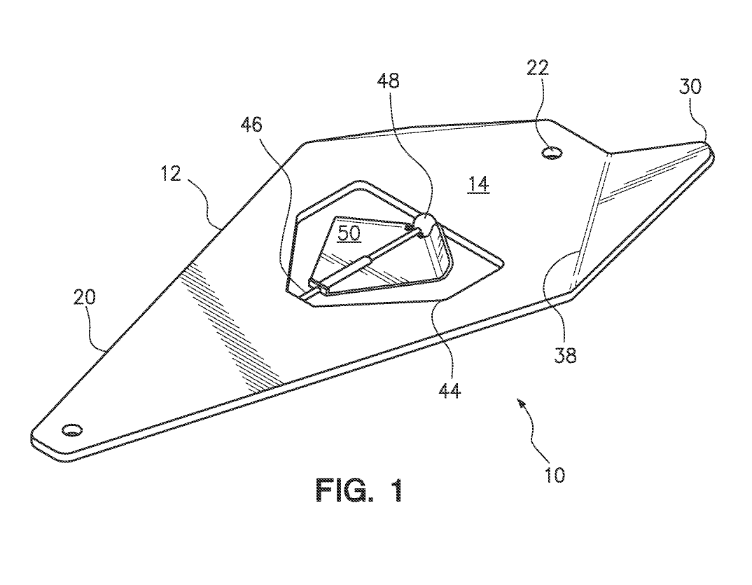

### DETAILED DISCUSSION OF THE PREFERRED EMBODIMENT

In the preferred embodiment, the disclosed fish attractor 10 has a substantially planar triangular body portion 12 that comprises a plane 14 with a first attachment point 20 at one apex, and a first bend 34 proximate a first distal apex 32 and a second bend 38 proximate a second distal apex 30.

The body 14 of the fish attractor may be comprised of transparent plastic in a clear or tinted form. It may also be made of metal or any useful rigid or semi-rigid material. The attractive qualities of the fish attractor body 14 may be augmented though application or incorporation of reflective material such as holographic tapes, foils or Mylar type tape to increase visibility. These may be applied to the surface of body 14 or incorporated within the body material 14. The use of reflective material may be limited to less than the full body 14 to increase the contrasting effect of the reflective material when the fish attractor 10 moves through the water.

Central to the plane 14 is an opening 44 for receiving either a two bladed spinner 50, or a four bladed spinner 60, which is mounted on an axle 46. It may be useful to add polished beads to act as bearings at the front of the spinner 62, or multiple beads are the base of the spinner 68 where there will be the most pressure. Such beads 48/62/68 may also be used to provide additional points of visual stimulation, vibration and noise generation

In operation a fishing line to a fisherman or pole or the like is attached to the first attachment point 20.

While in the preferred embodiment, the two bends 34, 38 are such that they provide rotational motive force on the fish attractor as it is pulled through the water, these bends are not needed or may be in the same direction, or may be curved. The bends 34, 38 are disclosed as merely the inventors' preferred embodiment of an improved fish attractor 10 with sound and vibration generation.

It is further disclosed that while a wide range of sizes may be useful, in the preferred embodiment for the widest range of uses, the body 14 of the fish attractor 10 is preferably between seven and nine inches long with an central opening 44 large enough for receiving a spinner 50/60 that is between one and two inches long. And while the body is preferably generally triangular in shape, the inventive qualities may also be appreciated in a circular, ovoid or rectangular body shape.

The spinner 50/60 may be of a material that matches the flasher 14, or it may be of a contrasting plastic or metal and may be augmented with reflective material such as holographic tapes, foils or Mylar type tape to increase visibility, applied to the surface of the spinner 50/60 or incorporated within the spinner 50/60 material. The use of reflective material may be limited to less than the full spinner to increase the contrasting effect of the reflective material when the spinner rotates.

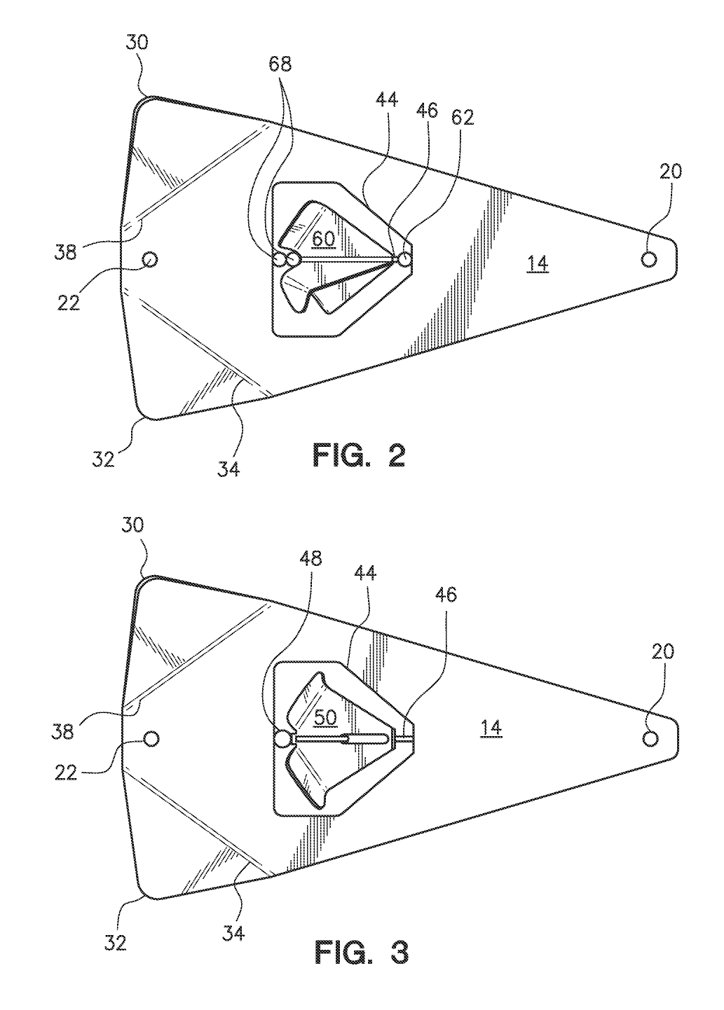

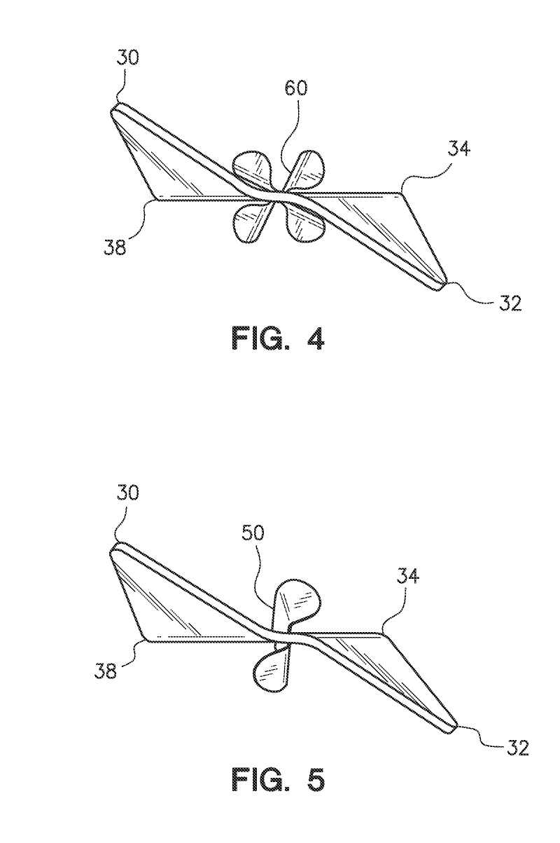

While a single piece central spinner 50 from a stamped or pressed type formation may be used with contrasting bends as depicted in FIGS. 3 and 5, the spinner may be of any form, including the four bladed spinner 60 as depicted in FIGS. 2 and 4.

As disclosed, the fish attractor 10 comprises a fish attractor with the ability to generate sound and vibration underwater that better attracts fish yet avoids the complications of exposed spinners or expensive components which are more prone to tangling and breaking.

Accordingly, the scope of the invention should be determined not by the embodiment illustrated, but by the appended claims and their legal equivalents.

I claim:

1. A fish attractor adapted to be attached to the end of a fishing line, the fish attractor comprising a generally planar body portion, the body portion comprising a plane having a base and an apex, the apex comprising a first centrally positioned aperture for attachment to the end of a fishing line, the base comprising a second centrally positioned aperture for attachment to a fishing hook, and a third opening positioned generally centrally in the body portion with a spinner disposed within said third opening whereby said spinner rotates and causes vibration and sound as the attractor moves through water.

2. The fish attractor of claim 1, wherein the body portion is comprised of plastic.

3. The fish attractor of claim 1, wherein the body portion is comprised of metal.

4. The fish attractor of claim 1, augmented with the use of reflective material with the body portion so as to not occlude said third opening in the body portion.

5. The fish attractor of claim 1, wherein less than the full body is augmented with reflective material.

6. The fish attractor of claim 1, wherein the spinner is augmented with the use of reflective material.

7. The fish attractor of claim 1, wherein the spinner is comprised of a clear material.

8. The fish attractor of claim 1, wherein the spinner is comprised of a reflective material.

9. The fish attractor of claim 1, wherein less than the full body of the spinner is augmented with reflective material.

10. The fish attractor of claim 1 wherein each of opposed ends of the base being bent out of the plane of the body portion in opposed directions to provide a pair of vanes to cause the attractor to rotate as it moves through water.

11. The fish attractor of claim 1 wherein each of opposed ends of the base being bent out of the plane of the body portion in the same direction to provide a pair of vanes to cause the attractor to undulate as it moves through water.
